(19) United States
(12) Patent Application Publication
(10) Pub. No.: US 2010/0050939 A1
(43) Pub. Date: Mar. 4, 2010

(54) METHOD FOR DETERMINING THE PERFORMANCE OF IMPLANTING APPARATUS

(75) Inventors: YU PIN HSU, PINGTUNG COUNTY (TW); YUAN MING CHANG, HSINCHU COUNTY (TW); WEI HENG LEE, TAICHUNG CITY (TW); CHENG DA WU, KEELUNG CITY (TW)

Correspondence Address: WPAT, PC;INTELLECTUAL PROPERTY ATTORNEYS, 2030 MAIN STREET, SUITE 1300, IRVINE, CA, 92614, US

(73) Assignee: PROMOS TECHNOLOGIES INC., HSINCHU (TW)

(21) Appl. No.: 12/198,326

(22) Filed: Aug. 26, 2008

(51) Int. Cl. B05C 11/00

(52) U.S. Cl. 118/712

(57) ABSTRACT

A method for determining the performance of an implanting apparatus comprises the steps of forming a dopant barrier layer on a substrate, forming a target layer on the dopant barrier layer, performing an implanting process by using the implanting apparatus to implant dopants into the target layer such that the target layer becomes conductive, measuring at least one electrical property of the target layer, and determining the performance of the implanting apparatus by taking the electrical property into consideration. In one embodiment of the present invention, the dopant barrier layer is silicon nitride layer, the target layer is a polysilicon layer, and the electrical property is the sheet resistance of the conductive polysilicon layer.

### BACKGROUND OF THE INVENTION

(A) Field of the Invention

The present invention relates to a method for determining the performance of an implanting apparatus, and more particularly, to a method for determining the performance of the implanting apparatus by using a recycling wafer.

(B) Description of the Related Art

There are a variety of important measurements that must be made on a semiconductor wafer to determine whether it is suitable for further fabrication processes and to make process adjustments. Examples of such measurements include doping concentration measurements, charge time retention measurements, and general leakage measurements. Current known measurement apparatus and techniques include probing technology through the use of mechanical probes, such as well-known 4-point probe techniques. However, the probes of the measurement apparatus contact the tested bare silicon wafer directly, which is destructive to the bare silicon wafer. The measured bare silicon wafer is used as a dummy or undergoes polishing for recycling. However, the thickness of the measured bare silicon wafer is reduced by 5-30 μm during the polishing process. Consequently, the recycling times of the measured bare silicon wafer is limited to the thickness decrease by the polishing process.

U.S. Pat. No. 5,914,611 discloses a method and apparatus for measuring sheet resistance and thickness of thin films and substrates. A four-point probe assembly engages the surface of a film on a substrate, and the thickness of the substrate is determined from the point of contact between the probes and film. A measuring apparatus then outputs a voltage waveform, which applies a voltage to probes of the probe assembly. An inverter inverts the voltage and provides the inverted voltage on another probe of the probe assembly, thus inducing a current in these probes of the four-point probe and through the surface of the film. Two other probes measure a voltage in the film created by the current. The voltages on the current probes provide a voltage close to zero at the other probes, thus allowing these other probes to measure voltages with greater precision. The current created by the voltage waveform and the voltage created across the inner probes are measured for each voltage level of the waveform. A sheet resistance of the film is determined by calculating the slope of a least square fit line of the measured current and voltage. The sheet resistance is proportional to the slope of the least square line.

### SUMMARY OF THE INVENTION

One aspect of the present invention provides a method for determining the performance of an implanting apparatus by using a recycling wafer having a dopant barrier layer and a polysilicon layer, which can be stripped after the destructive electrical measurement. A new dopant barrier layer and polysilicon layer can then be formed on the same wafer.

A method for determining the performance of an implanting apparatus according to this aspect of the present invention comprises the steps of forming a dopant barrier layer on a substrate, forming a target layer on the dopant barrier layer, performing an implanting process by using the implanting apparatus to implant dopants into the target layer, performing a thermal treating process, measuring at least one electrical property of the target layer, and determining the performance of the implanting apparatus by taking the electrical property into consideration. In one embodiment of the present invention, the dopant barrier layer is silicon nitride layer, the target layer is a polysilicon layer, and the electrical property is the sheet resistance of the conductive polysilicon layer.

The prior art uses the probes of the measurement apparatus to contact the bare silicon wafer under test directly, which is destructive to the bare silicon wafer; therefore, the measured bare silicon wafer must undergo polishing for recycle. However, the thickness of the measured bare silicon wafer will be reduced by 5-30 μm during the polishing process, and the recycling times of the measured bare silicon wafer is limited to the thickness decrease by the polishing process.

In contrast, the present invention monitors the performance of the implanting apparatus by using a recycling wafer including the dopant barrier layer and the target layer, and the probes of the measurement apparatus directly contact the target layer rather than the bare silicon wafer, and both the dopant barrier layer and the target layer can be stripped from the bare silicon wafer after the measurement. Subsequently, the bare silicon wafer can be deposited with the dopant barrier layer and the target layer for conducting further measurement without limitation since the thickness of the bare silicon wafer is not decreased.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become apparent upon reading the following description and upon reference to the accompanying drawings in which:

FIG. 1 and FIG. 2 illustrate a method for determining the performance of an implanting apparatus according to one embodiment of the present invention.

### DETAILED DESCRIPTION OF THE INVENTION

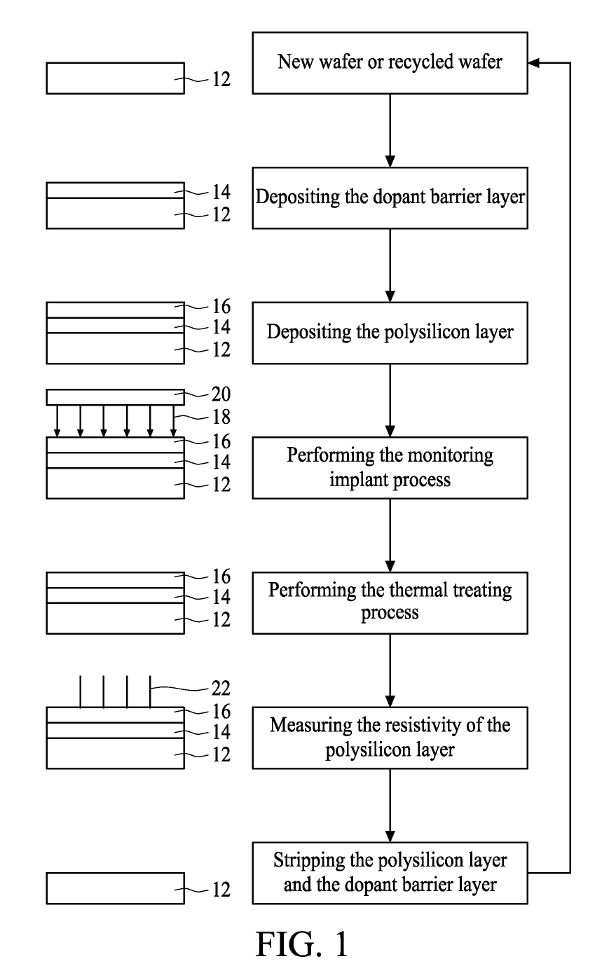

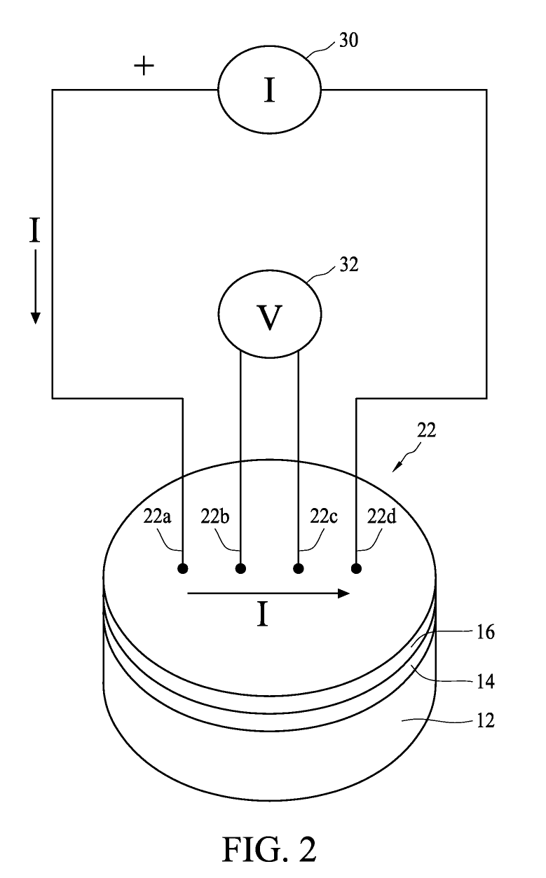

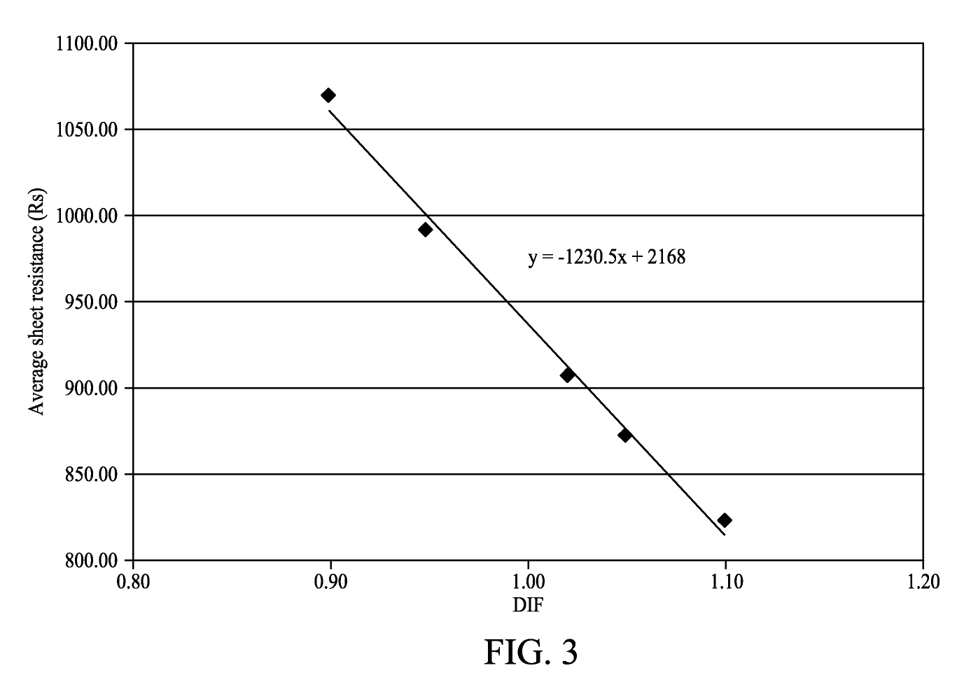

FIG. 1 and FIG. 2 illustrate a method for determining the performance of an implanting apparatus 20 according to one embodiment of the present invention. The deposition process is performed to form a dopant barrier layer 14 on a substrate 12 such as a new wafer or recycled wafer, and a target layer 16 is then formed on the dopant barrier layer 14. In one embodiment of the present invention, the dopant barrier layer 14 is a silicon nitride layer, and the target layer 16 is a doped polysilicon layer. The dopant barrier layer 14 functions to prevent dopant diffusion from the target layer 16 into the substrate 12.

An implanting process is performed by using the implanting apparatus 20 to implant dopants 18 into the target layer 16, and a thermal treating process such as the rapid thermal process (RTP) is then performed. The four-point probes 22 are used to measure electrical properties such as the sheet resistance of the target layer 16, which relates to the implanting dosage of the implanting apparatus 20 and can be used to monitor the performance of the implanting apparatus 20. Subsequently, the dopant barrier layer 14 and the target layer 16 are stripped from the substrate 12 by an etching process such as the wet etching process using an etchant including phosphoric acid.

The wet etching process can strip the dopant barrier layer 14 and the target layer 16 damaged by the four-point probes 22 during the sheet resistance measurement, without substantially damaging the substrate 12 or reducing the thickness of the substrate 12. Therefore, a new dopant barrier layer 14 and doped polysilicon layer 16 can be deposited on the same substrate 12 for further implanting process and sheet resistance measurement without limitation since the thickness of the substrate 12 is not substantially decreased.

Referring to FIG. 2, testing of sheet resistance of the conductive polysilicon layer 16 is done by using the four-point probe 22 that contacts the conductive polysilicon layer 16 on the substrate 12. The four-point probe 22 includes four linearly arranged probes 22a-d, where the two outer probes 22a and 22d direct a constant current (I) from a current source 30 through the conductive polysilicon layer 16 and the two inner probes 22b and 22c read the voltage drop created across the conductive polysilicon layer 16 by the current I on a voltmeter 32. Alternatively, probes 22a and 22c can direct the current I and probes 22b and 22d can read the voltage drop.

Following the voltage measurement, the sheet resistance Rs of the polysilicon layer 16 can be calculated from the following relationship:

$$Rs = k \frac{V}{I}$$

Where V is the voltage measured by the two inner probes 22c-d, I is the current flowing through the polysilicon layer 16, and k is a constant. This formula assumes that all four probes 22a-d are spaced apart equally.

FIG. 3 is a graph showing the average value of the sheet resistance at different dosages and the least square line calculated from the measurement points according to one embodiment of the present invention. The graph is prepared by using the implanting apparatus 20 to implant arsenic dopants at 50 KeV and different dosages into the polysilicon layer 16, and measuring the sheet resistance of the polysilicon layer 16. The implanting dosages are determined by multiplying a target dosage such as 1E15 by a dose trim factor (DTF). There are five average values in the graph and each average value is calculated from 5 measurement points with the same implanting recipe, i.e., the steps shown in FIG. 1 are repeated for 25 cycles and the implanting dosage are different from one DTF cycle to another DTF cycle.

Detailed implanting recipe and measured data are listed in the following table:

| | | | | | |
|---|---|---|---|---|---|
| DTF | 0.90 | 0.95 | 1.02 | 1.05 | 1.10 |
| | 1073.10 | 991.71 | 905.96 | 869.91 | 823.58 |
| | 1068.60 | 993.43 | 908.99 | 876.77 | 820.88 |
| | 1074.40 | 993.54 | 905.84 | 874.16 | 821.28 |
| | 1057.70 | 988.80 | 907.94 | 873.86 | 825.56 |
| | 1073.70 | 991.43 | 903.36 | 867.73 | none |
| Average | 1069.50 | 991.78 | 906.42 | 872.49 | 822.83 |
| Max-Min | 16.70 | 4.74 | 5.63 | 9.04 | 4.68 |
| Standard | 6.98 | 1.93 | 2.17 | 3.62 | 2.18 |
| Deviation | | | | | |

The standard deviations of the five measurements and the approximately linear measurement points clearly indicate the present invention's Rs measurement value of the doped polysilicon layer 16 is stable and suitable for determining the functioning or performance of the ion implanting apparatus 20.

The prior art uses the probes of the measurement apparatus to contact the bare silicon wafer under test directly, which is destructive to the bare silicon wafer; therefore, the measured bare silicon wafer must undergo polishing for recycle. However, the thickness of the measured bare silicon wafer will be reduced by 5-30 μm during the polishing process, and the recycling times of the measured bare silicon wafer is limited to the thickness decrease by the polishing process.

In contrast, the present invention monitors the performance of the implanting apparatus 20 by using the recycling wafer including the dopant barrier layer 14 and the conductive polysilicon layer 16, the probes of the measurement apparatus directly contact the conductive polysilicon layer 16 rather than the substrate 12, and both the dopant barrier layer 14 and the target layer 16 can be stripped from the substrate 12 after the sheet resistance measurement. Subsequently, the substrate 12 can be deposited with the new dopant barrier layer 14 and the conductive polysilicon layer 16 for conducting further implanting and sheet resistance measurement without limitation since the thickness of the substrate 12 is not decreased.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for determining the performance of an implanting apparatus, comprising the steps of:
(a) forming a dopant barrier layer on a substrate;
(b) forming a target layer on the dopant barrier layer;
(c) performing an implanting process by using the implanting apparatus to implant dopants into the target layer;
(d) measuring at least one electrical property of the target layer; and
determining the performance of the implanting apparatus by taking the electrical property into consideration.

2. The method for determining the performance of an implanting apparatus of claim 1, wherein the dopant barrier layer includes silicon nitride.

3. The method for determining the performance of an implanting apparatus of claim 1, wherein the target layer includes polysilicon.

4. The method for determining the performance of an implanting apparatus of claim 1, further comprising a step of performing a thermal treating process before measuring the electrical property of the target layer.

5. The method for determining the performance of an implanting apparatus of claim 4, wherein the thermal treating process is a rapid thermal process.

6. The method for determining the performance of an implanting apparatus of claim 1, wherein the electrical property is the sheet resistance.

7. The method for determining the performance of an implanting apparatus of claim 1, further comprising a step of:
(e) stripping the dopant barrier layer and the target layer from the substrate by an etching process.

8. The method for determining the performance of an implanting apparatus of claim 7, wherein the etching process is a wet etching process.

9. The method for determining the performance of an implanting apparatus of claim 8, wherein the wet etching process uses an etchant including phosphoric acid.

10. The method for determining the performance of an implanting apparatus of claim 7, further comprising a step of repeating the steps (a)-(e) for a predetermined cycle, wherein the implanting dosage of the step (c) is different.

11. The method for determining the performance of an implanting apparatus of claim 10, further comprising a step of correlating the measured electrical properties by the least squares approximation.
